(19) United States
(12) Patent Application Publication
(10) Pub. No.: US 2011/0155669 A1
(43) Pub. Date: Jun. 30, 2011

(54) METHOD FOR TRACE PHOSPHATE REMOVAL FROM WATER USING COMPOSITE RESIN

(75) Inventors: Bingcai Pan, Nanjing (CN); Bingjun Pan, Nanjing (CN); Qingjian Zhang, Nanjing (CN); Hui Qiu, Nanjing (CN); Weiming Zhang, Nanjing (CN); Qing Su, Nanjing (CN); Xinqing Chen, Nanjing (CN); Quanxing Zhang, Nanjing (CN)

(73) Assignee: NANJING UNIVERSITY, (CN)

(21) Appl. No.: 13/061,521

(22) PCT Filed: Aug. 10, 2009
(86) PCT No.: PCT/CN2009/000905

§ 371 Date: Mar. 1, 2011

(30) Foreign Application Priority Data
Sep. 3, 2008 (CN) 200810124787.7

(51) Int. Cl. C02F 1/42; C02F 1/66

(52) U.S. Cl. 210/663

(57) ABSTRACT

The invention discloses a novel method for trace phosphate removal from water by using a composite resin. Firstly, adjusting the pH value of the raw water to 5.0˜9.0 and prefiltering the water, then leading the filtrate through an absorption tower packed with the composite resin, the trace phosphate in the water is therefore absorbed onto the composite resin; stopping the absorption run when it reaches the leakage point, using a binary NaOH-NaCl solution as the regenerant of the exhausted sorbent, followed by rinsing the composite resin-filled absorption tower with saturated carbon dioxide solution to regenerate the resin. In this invention, a composite resin with nanosized hydrated ferric oxide (HFO) or hydrous manganese dioxide (HMO) particles loaded on its surface is adopted as the absorbent for enhanced phosphate removal from water. A significant decrease of phosphate content in the effluent from this treatment system is found from 0.05-20 ppm to less than 20 ppb (calculated in P), despite of the coexisting competing anions as sulfate, chloride, and hydrocarbonate at much higher molar concentrations than phosphate. This invention is characteristic of large treatment capacity and efficient regeneration for repeated use of the absorbent.

### FIELD OF TECHNOLOGY

This invention relates to a trace phosphate removal method for water purification. More particularly, it relates to a method using a composite resin with high capacity and selectivity for phosphate to remove trace phosphorus from water.

### BACKGROUND

Phosphate is one of nutritional elements that may cause severe eutrophication of the receiving waterways. So it is of great significance for water safety to deeply remove trace phosphate from water. Accordingly, all the countries and regions around the world are continuously developing new tertiary treatment techniques to meet the increasingly stringent standards for phosphate discharge. Most commonly, these techniques adopt physicochemical or biochemical processes for phosphate removal, with generally high operation cost and probability of secondary pollution by sludge formed therein, which often fail to achieve the desirably lower concentration of phosphate in the effluent.

Extensive researches, at home and abroad, have indicated that the fixed-bed absorption is a highly efficient purification method of pollutants. Water phosphate exists commonly in form of hydrogen phosphate anion. In micro-polluted water, the concentrations of the coexisting competitive ions in water such as sulfate, chloride and carbonate are at a much higher level than that of phosphate, which requires a regenerable and reuseable absorbent with high selectivity for phosphate and moderate cost. However, traditional absorbents including activated carbon, ion exchange resin and zeolite display poor specific adsorption affinity toward phosphate due to the restriction of their nonspecific mechanisms like electrostatic interaction; till now, no report has been found on adsorption technologies for deep removal of trace phosphate from water. In recent decades, hydrated ferric oxide (HFO) and hydrous manganese dioxide (HMO) particles have proved to exhibit high absorption selectivity on the Group IV elements (including As, P and others), and to be regenerable for repeated use by adjusting the pH value. Unfortunately, these two inorganic particles are usually present in fine sizes (usually in micron or nanometer dimensions) and are easy to cause excessive pressure drop when employed in fixed-bed process, leading to a rapid failure of the whole absorption system. In recent years, a Chinese research team led by Professor Pan BingCai from Nanjing University has successfully developed a series of organic-inorganic composite resin materials by loading the nanosized HFO, HMO and other inorganic particles onto the surface of resin adsorbents through surface deposition technique, which solved the difficult problems of deep water purification through removal of various pollutants like heavy metals and arsenic at trace level (Pan, Bingcai, et, al. “Resin-based Hydrous Ferric Oxide Prepared on the Basis of Donnan Membrane Effect and Its Absorption Performance on Arsenic.” Science in China (Series B: Chemistry) 37 (2007): 426-431); Zhang, Qingrui, Pan, Bingcai, et, al. “Selective Sorption of Lead, Cadmium and Zinc ions by a Polymeric Cation Exchanger Containing Nano-Zr(HPO₃S)₂. Environmental Science & Technology 42.11 (2008): 4140-4145). This new composite material make up the traditional resin adsorbent in lack of special selectivity toward target pollutants, and overcome the issues involving excessive pressure drop when the inorganic ultrafine particles of the absorbents are employed for direct use in flow-through systems. Meanwhile, the adsorptive selectivity toward target pollutants and the effective adsorption capacity are enhanced through the Donnan membrane effect resulting from the immobilized charges on the resin surface.

Literature search shows that no methods on trace phosphate removal from water using a composite resin have heretofore been disclosed.

### DESCRIPTION

1. The Technical Problem to be Solved

The purpose of the present invention is to provide a method for deep phosphate removal from water using a composite resin. Overcoming the problems in poor specificity and low processing depth of traditional techniques, the present invention permits an effective removal of most of the phosphate in the effluent in the presence of coexisting competitive ions like Cl⁻, HCO₃⁻and SO₄²⁻in far higher molar concentrations than phosphate.

2. Technical Solution

The technical solution provided in this invention includes:

A) adjusting the pH value of the water containing trace phosphate [existing in P(V) state] to 5.0˜9.0, and then leading the water through a filter so that suspended particles in the water are removed.

B) leading the filtrate obtained in Step A) through the absorption tower packed with the composite resin so that the trace phosphate in the water is absorbed onto the composite resin.

C) stopping the absorption run when it reaches the leakage point, using a binary NaOH-NaCl solution as the regenerant of the exhausted sorbent, followed by rinsing the composite resin-filled absorption tower with saturated carbon dioxide solution so that the resin is regenerated.

The concentration of PO₄³⁻in the water mentioned in Step A) is 0.05˜20 ppm (calculated in P), while the concentrations of other coexisting Cl⁻, HCO₃⁻and SO₄²⁻ions are within 500 times of it.

In Step B), keeping the temperature of the filtrate obtained in Step A) at 5˜40° C. and leading it through the absorption tower packed with the organic-inorganic composite resin at the flow velocity of 5-50 BV/h (BV refers to bed volume of resin). The said composite resin uses a macroporous strongly basic anion exchange resin D-201 as the support matrix for the loading of nanoparticulate hydrated ferric oxide (HFO) or hydrous manganese dioxide (HMO), in which the content of hydrated ferric oxide (HFO) or hydrous manganese dioxide (HMO) particles is controlled around 2-25% (calculated in Fe or Mn).

In Step C), the leakage point is settled at the point when the phosphate concentration in the effluent reaches above 20 ppb calculated in P. The desorbent works at 15-60° C. and at a 1-5 BV/h flow velocity for desorbing and regenerating the composite resin. A saturated carbon dioxide solution at 2-8 BV is adopted to rinse the absorption tower packed with the composite resin so that the resin can be regenerated. The binary solution mentioned in Step C) contains 1˜10% NaOH and NaCl in mass, respectively.

3. Beneficial Effects

This invention provides a method for deep phosphate removal from water using a composite resin; the composite resin in the said method is adopted as a trace phosphate adsorbent for water purification, on the surface of which nanosized hydrated ferric oxide (HFO) or hydrous manganese dioxide (HMO) particles are supported. A significant decrease of phosphate content in the effluent from this treatment system is found from 0.05-20 ppm to less than 20 ppb (calculated in P), despite of the coexisting competing anions as sulfate, chloride, and hydrocarbonate at much higher molar concentrations than phosphate. This invention is characteristic of large treatment capacity and efficient regeneration for repeated use of the absorbent.

### DETAILED DESCRIPTION

This invention is further illustrated in the following exemplary embodiments.

### Embodiment I

Packing 50 ml (about 40 g) composite resin HFO-D201, consisting of a strongly basic macroporous anion resin D-201 as support matrix and 10% nanoparticulate hydrated ferric oxide (calculated in Fe) supported thereon, into a jacketed glass absorption column (ψ32 ×360 mm); then, at 25±5° C. adjusting the pH value of the filtrate [namely the water being filtered away suspended particles and containing 1 ppm of phosphorus (V), with the concentration of Cl⁻, HCO₃⁻and SO₄²⁻being 100, 100, and 150 ppm respectively] to 7 and leading it through the resin bed at the flow velocity of 15 BV/h; the total treatment capacity is 4000 BV and the concentration of PO₄³⁻in the effluent drops to less than 20 ppb.

Stopping the absorption run when it reaches the leakage point (namely, when the concentration of PO₄³⁻in the effluent reaches above 20 ppb); desorbing the resin bed at 30±5° C. with 300 ml mixed NaOH-NaCl solution (2% in mass respectively) down-flowing the resin bed at a rate of 50 ml/h, the desorption efficiency is higher than 98%; then adopting 250 ml CO₂-saturated solution for regeneration. The overall regeneration rate of the absorbent is higher than 99.9%.

### Embodiment II

The absorption devices used herein is the same as Embodiment I, while the temperature for absorption is controlled at lower than 5±2° C., the result indicates that the absorption effect and treatment capacity remains almost unchanged.

### Embodiment III

The absorption devices used herein is the same as Embodiment I, while the temperature for absorption is controlled at lower than 40±5° C., the result indicates that the absorption effect and treatment capacity remains almost unchanged.

### Embodiment IV

Packing 100 ml (about 85 g) composite resin HFO-D201, consisting of a strongly basic macroporous anion resin D-201 as support matrix and 15% nanoparticulate hydrated ferric oxide (calculated in Fe) supported thereon, into a jacketed glass absorption column (Φ32×360 mm); then, at 25±5° C., adjusting the pH value of the filtrate [namely the water being filtered away suspended particles and containing 0.5 ppm of phosphorus (V), with the concentration of Cl⁻, HCO₃⁻and SO₄²⁻being 80, 100, and 100 ppm respectively] to 7.5 and leading it through the resin bed at the flow velocity of 20 BV/h; the total treatment capacity is about 7000 BV and the concentration of PO₄³⁻in the effluent drops to less than 10 ppb.

Stopping the absorption run when it reaches the leakage point (namely, when the concentration of PO₄³⁻in the effluent reaches above 10 ppb); desorbing the resin bed at 40±5° C. with 400 ml mixed NaOH-NaCl solution (5% in mass respectively) down-flowing the resin bed at a rate of 50 ml/h, the desorption efficiency is higher than 99%; then adopting 200 ml CO₂-saturated solution for regeneration. The overall regeneration rate of the absorbent is higher than 99.9%.

### Embodiment V

Packing 20 ml (about 16 g) composite resin HFO-D201, consisting of a strongly basic macroporous anion resin D-201 as support matrix and 10% nanoparticulate hydrated ferric oxide (calculated in Fe) supported thereon, into a jacketed glass absorption column (Φ16×200 mm); then, at 25±5° C. adjusting the pH value of the filtrate [namely the water being filtered away suspended particles and containing 0.1 ppm of phosphorus (V), with the concentration of Cl⁻, HCO₃⁻and SO₄²⁻being 50, 50, and 80 ppm respectively] to 7.0 and leading it through the resin bed at the flow velocity of 25 BV/h; the total treatment capacity is above 12000 BV and the concentration of PO₄³⁻in the effluent drops to less than 20 ppb.

Stopping the absorption run when it reaches the leakage point (namely, when the concentration of PO₄³⁻in the effluent reaches above 10 ppb); desorbing the resin bed at 40±5° C. with 100 ml mixed NaOH-NaCl solution (4% in mass respectively) down-flowing the resin bed at a rate of 20 ml/h, the desorption efficiency is higher than 99%; then adopting 200 ml CO₂-saturated solution for regeneration. The overall regeneration rate of the absorbent is higher than 99.9%.

### Embodiment VI

Packing 200 ml (about 170 g) composite resin HFO-D201, consisting of a strongly basic macroporous anion resin D-201 as support matrix and 15% nanoparticulate hydrated ferric oxide (calculated in Fe) supported thereon, into a jacketed glass absorption column (Φ40×360 mm); then, at 25±5° C. adjusting the pH value of the filtrate [namely the water being filtered away suspended particles and containing 20 ppm of phosphorus (V), with the concentration of Cl⁻, HCO₃⁻and SO₄²⁻being 200, 200, and 500 ppm respectively] to 7.0 and leading it through the resin bed at the flow velocity of 5 BV/h; the total treatment capacity is about 400 BV and the concentration of PO₄³⁻in the effluent drops to less than 20 ppb.

Stopping the absorption run when it reaches the leakage point (namely, when the concentration of PO₄³⁻in the effluent reaches above 20 ppb); desorbing the resin bed at 40±5° C. with 800 ml mixed NaOH-NaCl solution (5% in mass respectively) down-flowing the resin bed at a rate of 200 ml/h, the desorption efficiency is higher than 97%; then adopting 600 ml CO₂-saturated solution for regeneration. The overall regeneration rate of the absorbent is higher than 99.9%.

### Embodiment VII

Packing 50 ml (about 33 g) composite resin HFO-D201, consisting of a strongly basic macroporous anion resin D-201 as support matrix and 2% nanoparticulate hydrated ferric oxide (calculated in Fe) supported thereon, into a jacketed glass absorption column (Φ32×360 mm); then, at 25±5° C., adjusting the pH value of the filtrate [namely the water being filtered away suspended particles and containing 1 ppm of phosphorus (V), with the concentration of Cl⁻, HCO₃⁻and SO₄²⁻being 100, 100, and 150 ppm respectively] to 8 and leading it through the resin bed at the flow velocity of 15 BV/h; the total treatment capacity is about 1000 BV and the concentration of PO₄³⁻in the effluent drops to less than 20 ppb.

Stopping the absorption run when it reaches the leakage point (namely, when the concentration of PO₄³⁻in the effluent reaches above 20 ppb); desorbing the resin bed at 30±5° C. with 300 ml mixed NaOH-NaCl solution (2% in mass respectively) down-flowing the resin bed at a rate of 50 ml/h, the desorption efficiency is higher than 98%; then adopting 250 ml CO₂-saturated solution for regeneration. The overall regeneration rate of the absorbent is higher than 99.9%.

### Embodiment VIII

Packing 50 ml (about 52 g) composite resin HFO-D201, consisting of a strongly basic macroporous anion resin D-201 as support matrix and 25% nanoparticulate hydrated ferric oxide (calculated in Fe) supported thereon, into a jacketed glass absorption column (Φ32×360 mm); then, at 25±5° C., adjusting the pH value of the filtrate [namely the water being filtered away suspended particles and containing 1 ppm of phosphorus (V), with the concentration of Cl⁻, HCO₃⁻and SO₄²⁻being 100, 100, and 150 ppm respectively] to 7 and leading it through the resin bed at the flow velocity of 15 BV/h; the total treatment capacity is 3000 BV and the concentration of PO₄³⁻in the effluent drops to less than 20 ppb.

Stopping the absorption run when it reaches the leakage point (namely, when the concentration of PO₄³⁻in the effluent reaches above 20 ppb); desorbing the resin bed at 30±5° C. with 300 ml mixed NaOH-NaCl solution (2% in mass respectively) down-flowing the resin bed at a rate of 50 ml/h, the desorption efficiency is higher than 98%; then adopting 250 ml CO₂-saturated solution for regeneration. The overall regeneration rate of the absorbent is higher than 99.9%.

### Embodiment IX

Packing 50 ml (about 40 g) composite resin HFO-D201, consisting of a strongly basic macroporous anion resin D-201 as support matrix and 10% nanoparticulate hydrated ferric oxide (calculated in Fe) supported thereon, into a jacketed glass absorption column (Φ32×360 mm); then, at 25±5° C., adjusting the pH value of the filtrate [namely the water being filtered away suspended particles and containing 0.05 ppm of phosphorus (V), with the concentration of Cl⁻, HCO₃⁻and SO₄²⁻being 50, 50, and 50 ppm respectively] to 7 and leading it through the resin bed at the flow velocity of 50 BV/h; the total treatment capacity is above 20000 BV and the concentration of PO₄³⁻in the effluent drops to less than 5 ppb.

Stopping the absorption run when it reaches the leakage point (namely, when the concentration of PO₄³⁻in the effluent reaches above 5 ppb); desorbing the resin bed at 40±5° C. with 400 ml mixed NaOH-NaCl solution (2% in mass respectively) down-flowing the resin bed at a rate of 50 ml/h, the desorption efficiency is higher than 99%; then adopting 250 ml CO₂-saturated solution for regeneration. The overall regeneration rate of the absorbent is higher than 99.9%.

### Embodiment X

The absorption devices used herein is the same as Embodiment I, while the absorbent therein is changed with the organic-inorganic composite resin consisting of D-201 as support matrix and inorganic nanoparticulate hydrous manganese dioxide (HMO) particles supported thereon. Except that the treatment capacity varies in different batches, the other results remain almost unchanged.

1. A method for deep phosphate removal from water using a composite resin, including the following steps:
A) adjusting the pH value of the water containing trace phosphate to 5.0˜9.0, and then leading the water through a filter so that suspended particles in the water are removed;
B) leading the filtrate obtained in Step A) through the absorption tower packed with the composite resin so that the trace phosphate in the water is absorbed onto the composite resin;
C) stopping the absorption run when it reaches the leakage point, using a binary NaOH-NaCl solution as the regenerant of the exhausted sorbent, followed by rinsing the composite resin-filled absorption tower with saturated carbon dioxide solution so that the resin is regenerated.

2. The method for deep phosphate removal from water using a composite resin according to claim 1, wherein the concentration of PO₄³⁻in the water mentioned in Step A) is 0.05˜20 ppm (calculated in P), while the concentrations of coexisting anions are within 500 times of it.

3. The method for deep phosphate removal from water using a composite resin according to claim 2, wherein the composite resin mentioned in Step B) is an anion exchange resin on the surface of which is supported with nanosized hydrated ferric oxide (HFO) or hydrous manganese dioxide (HMO) particles; the said anion exchange resin belongs to strongly basic macroporous anion resin or strongly basic gel anion resin.

4. The method for deep phosphate removal from water using a composite resin according to claim 3, wherein the operation temperature mentioned in Step B) is at 5˜40° C. and the filtrate flow velocity is 5˜50 resin bed volume per hour.

5. The method for deep phosphate removal from water using a composite resin according to claim 1, wherein absorption tower mentioned in Step B) can be operated in either single-tower absorption and desorption mode or multi-tower series absorption and single-tower desorption mode.

6. The method for deep phosphate removal from water using a composite resin according to claim 1, wherein the leakage point mentioned in Step C) refers to the point when the concentration of PO₄³⁻in the effluent reaches above 20 ppb (calculated in P).

7. The method for deep phosphate removal from water using a composite resin according to claim 1, wherein the binary solution mentioned in Step C) contains 1˜10% NaOH and NaCl in mass respectively, and the desorption and regeneration is operated at 15-60° C. with a flow velocity of 1-5 BV/h.

8. The method for deep phosphate removal from water using a composite resin according to claim 1, wherein the saturated carbon dioxide solution mentioned in Step C) is 2-8 BV for rinsing the absorption tower.
